(19) United States
(12) Patent Application Publication
(10) Pub. No.: US 2022/0111538 A1
(43) Pub. Date: Apr. 14, 2022

(54) END EFFECTOR AND ROBOT WITH THE SAME

(71) Applicant: KAWASAKI JUKOGYO KABUSHIKI KAISHA, Kobe-shi, Hyogo (JP)

(72) Inventors: Toshiyuki TSUJIMORI, Kobe-shi (JP); Shoichi MIYAO, Kobe-shi (JP); Hideshi YAMANE, Kobe-shi (JP); Kentaro AZUMA, Kobe-shi (JP); Kazunori HIRATA, Kobe-shi (JP); Yukio IWASAKI, Kobe-shi (JP); Ippei NAGAHIRO, Kobe-shi (JP)

(73) Assignee: KAWASAKI JUKOGYO KABUSHIKI KAISHA, Kobe-shi, Hyogo (JP)

(21) Appl. No.: 17/418,912

(22) PCT Filed: Dec. 26, 2019
(86) PCT No.: PCT/JP2019/051257

§ 371 Date: Jun. 28, 2021

(30) Foreign Application Priority Data
Dec. 28, 2018 (JP) 2018-247989

(51) Int. Cl. B25J 15/00; B25J 19/02; B65B 69/00

(52) U.S. Cl. CPC B25J 15/0066; B25J 15/0028; B65B 69/0041; B25J 19/02; B25J 15/0071

(57) ABSTRACT

An end effector is to be attached to a tip-end part of a robotic arm and unpacks a cardboard box of which one or more flaps provided to one end of a side wall are fixed mutually or to the side wall to constitute one of end walls. The end effector includes a body part to be attached to the tip-end part of the robotic arm, a box holding part provided to the body part and configured to hold the cardboard box by holding a part of the cardboard box other than the one end wall, and a punching part provided to the body part and configured to form a through-hole in a wall of the cardboard box other than the one end wall.

### TECHNICAL FIELD

The present disclosure relates to an end effector and a robot with the same.

### BACKGROUND ART

Conventionally, a technology for unpacking a package by using a robot is known. For example, according to an unpacking device disclosed in Patent Document 1, it makes a cardboard box which is packed with contents and is sealed, upside down, cuts a bottom lid, and then flips the upside-down cardboard box over back to the normal posture by a dual-arm robot gripping the cardboard box to drop the contents by their own weight, and, thereby, the contents are taken out from the cardboard box.

### REFERENCE DOCUMENT OF CONVENTIONAL ART

### [Patent Document]

[Patent Document 1] JP2013-100118A

### DESCRIPTION OF THE DISCLOSURE

### Problem to be Solved by the Disclosure

However, the contents may not come out from the box only by trying to drop the contents by their own weight like the conventional technology described above. For example, this may be a case where plastic bags which are filled with nuts are stuffed and packed into a cardboard box. This happens because the self-dropping of the contents is impeded by negative pressure which is caused in a gap between the plastic bag which is slipped down to the middle and an upper lid, a frictional force which is caused between the plastic bag and the cardboard box, for example.

The present disclosure is made in order to solve the above problem, and one purpose thereof is to provide an end effector and a robot on which the end effector is mounted (attached), which are capable of easily taking out contents from a cardboard box by stimulating a self-dropping of the contents, when unpacking the cardboard box using the robot.

### SUMMARY OF THE DISCLOSURE

In order to achieve the above purpose, an end effector according to one aspect of the present disclosure is an end effector to be attached to a tip-end part of a robotic arm and configured to unpack a cardboard box of which one or more flaps provided to one end of a side wall are fixed mutually or to the side wall to constitute one of end walls. The end effector includes a body part to be attached to the tip-end part of the robotic arm, a box holding part provided to the body part and configured to hold the cardboard box by holding a part of the cardboard box other than the one end wall, and a punching part provided to the body part and configured to form a through-hole in a wall of the cardboard box other than the one end wall. Here, the “end wall(s)” refers to a lid wall (top wall) and a bottom wall.

According to this configuration, the end effector is attached to the tip-end part of the robotic arm via the body part. Then, the cardboard box is unpacked as follows, for example. That is, the robotic arm holds the cardboard box by the box holding part of the end effector. At this time, the through-hole is formed in the wall of the cardboard box other than the one end wall by the punching part. Then, the robotic arm presses the one end wall of the cardboard box against a suitably fixed cutter while moving the cardboard box, to cut the flaps of the one end wall of the cardboard box so that the flaps are opened. Then, the cardboard box is turned so that the one end wall is turned downwardly. In this way, the contents of the cardboard box start to fall by their own weight. Here, even if a gap is produced between the contents which slipped down to the middle and the other end wall, since the through-hole is formed in the wall other than the one end wall, air outside the cardboard box or pressurized air from a pressurized air supply is supplied to the inside of the cardboard box through the through-hole. Therefore, it is suppressed that the gap becomes at negative pressure, thereby stimulating the self-dropping of the contents. Therefore, the contents can be easily taken out from the cardboard box.

The box holding part may include an end-wall holding part configured to hold the other end wall of the cardboard box, and a pair of side wall holding parts configured to hold a pair of side walls of the cardboard box opposing to each other. The punching part may form the through-hole in the other end wall and/or the side wall of the cardboard box. Here, the “other end wall and/or the side wall” includes a case of both the other end wall and the side wall, a case of only the other end wall, and a case of only the side wall.

According to this configuration, when a plurality of cardboard boxes are stacked on a pallet, after the end effector is attached to the tip-end part of the robotic arm via the body part, for example, the robotic arm lifts one of the plurality of cardboard boxes stacked on the pallet by the end-wall holding part of the end effector holding the other end wall of the cardboard box, and when the cardboard box is lifted to a height where the pair of side wall holding parts can perform a holding operation, the robotic arm can hold the pair of side walls of the cardboard box by the pair of side wall holding parts of the end effector. Therefore, when the plurality of cardboard boxes are stacked on the pallet, the contents can be easily taken out from the cardboard box.

The end-wall holding part may be a suction part configured to suck the other end wall of the cardboard box.

According to this configuration, the other end wall of the cardboard box can be held with a simple configuration.

The pair of side wall holding parts may include a pair of swinging members, each having a pawl and/or a friction member. When the body part is located above the cardboard box, the pair of swinging members may swing centering on a part of the body part located above the pair of side walls to stick the pawls into and/or press the friction members against the pair of side walls, respectively, to grip the cardboard box. Here, “having a pawl and/or a friction member” includes a case of having both the pawl and the friction member, a case of having only the pawl, and a case of having only the friction member. Moreover, “to stick the pawls into and/or press the friction members against” includes a case of sticking the pawls and also pressing the friction members, a case of only sticking the pawls, and a case of only pressing the friction members.

According to this configuration, since the pair of side walls can be gripped by the pair of swinging members being swung, the side walls can be firmly held with the simple configuration.

The punching part may include a nozzle configured to discharge at least pressurized air, and a nozzle moving mechanism configured to move the nozzle between an operating position where the nozzle penetrates the other end wall or the side wall of the cardboard box and a standby position where the nozzle separates from the other end wall or the side wall of the cardboard box.

According to this configuration, the nozzle can be caused to suitably penetrate the other end wall or the side wall of the cardboard box by the nozzle moving mechanism. Moreover, when the cardboard box is turned so that the one end wall is turned downwardly and the contents of the cardboard box start to fall by their own weight, and the gap is produced between the contents which slipped down to the middle and the other end wall, the self-dropping of the contents by their own weight is stimulated by the nozzle discharging the pressurized air. Therefore, the contents can be taken out from the cardboard box more easily.

The nozzle may be an end wall nozzle configured to suck air and discharge the pressurized air, and the nozzle moving mechanism may be an end wall nozzle moving mechanism configured to move the nozzle between an operating position where the end wall nozzle penetrates the other end wall of the cardboard box and a standby position where the nozzle separates from the other end wall of the cardboard box.

According to this configuration, the end wall nozzle can be caused to suitably penetrate the other end wall of the cardboard box by the end wall nozzle moving mechanism. Moreover, when the posture of the cardboard box is changed by the robotic arm so that the other end wall is turned upwardly to cut the one end wall of the cardboard box, the contents are moved downwardly by sucking the air inside the cardboard box from the end wall nozzle, thereby forming a gap between the contents and the one end wall, which is larger than the gap formed due to the own weight of the contents. As a result, a risk of damaging the contents when cutting the flap of the one end wall by the cutter can be reduced. Moreover, when the cardboard box is turned so that the one end wall is turned downwardly, the contents can be pushed downwardly by the nozzle discharging the pressurized air, thereby greatly stimulating the self-dropping of the contents. Therefore, the contents can be taken out from the cardboard box further more easily.

The pair of side wall holding parts may include a pair of swinging members, each having a pawl and/or a friction member. When the body part is located above the cardboard box, the pair of swinging members may swing centering on a part of the body part located above the pair of side walls to stick the pawl into and/or press the friction member against the pair of side walls, respectively, to grip the cardboard box. The pair of swinging members may constitute the nozzle moving mechanism. The nozzle may be a pair of side wall nozzles configured to discharge pressurized air. The pair of side wall nozzles may be provided to the pair of swinging members so that, when the pair of swinging members swing so that the pair of swinging members grip the cardboard box, the pair of side wall nozzles penetrate the pair of side walls of the cardboard box, and when the pair of swinging members swing so that the pair of swinging members release the cardboard box, the pair of side wall nozzles separate from the pair of side walls of the cardboard box.

According to this configuration, the pair of side wall nozzles can be caused to suitably penetrate the one end wall of the cardboard box by the pair of swinging members. Moreover, when the cardboard box is turned by the robotic arm so that the one end wall is oriented downwardly, a frictional force between the contents and the pair of side walls is reduced by discharging the pressurized air from the pair of side wall nozzles. Moreover, when the contents slip downwardly from the pair of side wall nozzles, the air discharged from the pair of side wall nozzles pushes the contents downwardly. Thus, the self-dropping of the contents is greatly stimulated, and therefore, the contents can be taken out from the cardboard box further more easily.

The end effector may include a three-dimensional position measuring instrument configured to measure the position of the cardboard box, and a box position identifying part configured to identify the three-dimensional position of the cardboard box based on the three-dimensional position measured by the three-dimensional position measuring instrument.

According to this configuration, since the three-dimensional position of the cardboard box is identified by the box position identifying part, the end effector can appropriately hold the cardboard box.

A robot according to another aspect of the present disclosure is a robot in which the end effector of any one described above is attached to the tip-end part of the robotic arm.

According to this configuration, by stimulating the self-dropping of the contents when unpacking the cardboard box, the contents can be easily taken out from the cardboard box.

### Effects of the Disclosure

The present disclosure can provide an end effector and a robot with the same, which are capable of easily taking out contents from a cardboard box by stimulating self-dropping of the contents, when unpacking the cardboard box using the robot.

### BRIEF DESCRIPTION OF DRAWINGS

FIG. 1 is a front view illustrating a configuration of hardware of an end effector according to Embodiment 1 of the present disclosure.

FIG. 2 is a block diagram illustrating a configuration of a control system of the end effector of FIG. 1.

FIG. 3 is a perspective view illustrating a lifting operation of a cardboard box by a robotic arm.

FIG. 4 is a front view illustrating the end effector in a state where it holds the cardboard box.

FIG. 5 is a perspective view illustrating a cutting operation of a lower wall of the cardboard box by the robotic arm.

FIG. 6 is a front view illustrating the end effector when cutting the lower wall of the cardboard box.

FIG. 7 is a front view illustrating the end effector in a state where contents are dropped from the cardboard box of which the lower wall is opened.

FIG. 8 is a perspective view illustrating an operation where the contents are dropped by the robotic arm from the cardboard box of which the lower wall is opened.

FIG. 9 is a cross-sectional view illustrating a configuration of a side wall nozzle of an end effector according to Modification 1.

FIG. 10 is a cross-sectional view illustrating a configuration of a punch member of an end effector according to Modification 2.

### MODES FOR CARRYING OUT THE DISCLOSURE

Hereinafter, one embodiment of the present disclosure is described with reference to the drawings. Note that, below, the same reference characters are assigned to the same or corresponding elements throughout the drawings to omit redundant description. Moreover, since the following drawings are for explaining the present disclosure, an element which is unrelated to the present disclosure may be omitted, a dimension may not be exact for exaggeration etc., elements corresponding to each other in a plurality of drawings may not be in agreement with each other. Moreover, the present disclosure is not limited to the following embodiment.

### Embodiment 1

### [Directions]

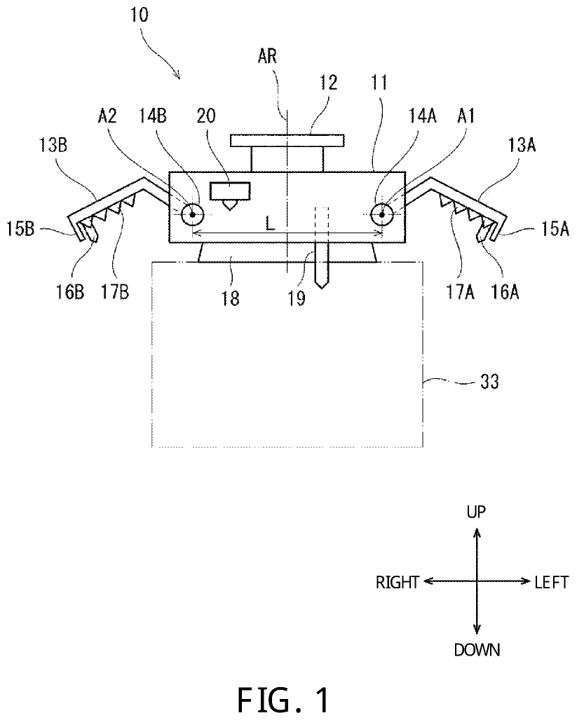

As for the directions in a space, an up-and-down direction in FIGS. 1-8 represents an up-and-down direction in the space. As for the directions of an end effector 10, for convenience, the up-and-down direction of FIG. 1 is referred to as an up-and-down direction of the end effector, and the right and the left in FIG. 1 are referred to as the left and the right of the end effector 10, respectively. As for the directions of a cardboard box 33, the up-and-down direction in FIG. 1 is referred to as an up-and-down direction of the cardboard box 33, and the right and the left of FIG. 1 are referred to as the left and the right of the cardboard box 33, respectively.

### [Configuration]

### {Configuration of Hardware}

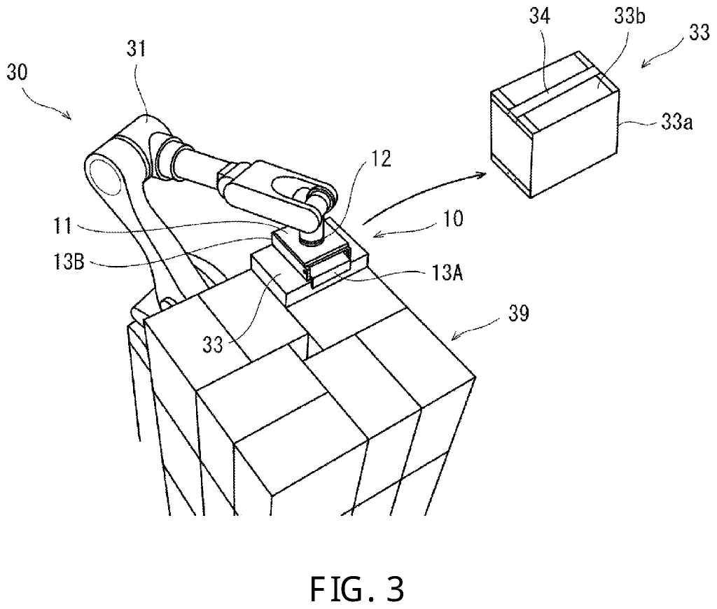

FIG. 1 is a front view illustrating a configuration of hardware of the end effector according to Embodiment 1 of the present disclosure. Note that, in FIGS. 1, 4, 6, and 7, a pair of pawls 15A and 15B, a pair of side wall nozzles 16A and 16B, and an upper wall nozzle 19 are exaggerated and drawn largely for easier understandings. Actually, these are created small enough so that contents 36 may not be damaged. FIG. 3 is a perspective view illustrating a lifting operation of the cardboard box by the robot.

Referring to FIG. 3, the end effector 10 of this embodiment is attached to a tip-end part of a robotic arm 31 of a robot 30 and is an end effector for unpacking the cardboard box 33 in which one or more flaps 33b provided to one end of a side wall(s) is fixed mutually or to the side wall to constitute an upper wall (one of end walls).

Referring to FIGS. 1 and 3, the end effector 10 includes a body part 11 which is attached to the tip-end part of the robotic arm 31, box holding parts 13A, 13B, and 18 which are provided to the body part 11 and hold the cardboard box by holding a part of the cardboard box 33 other than a lower wall, and punching parts 16A, 17A, and 19 which are provided to the body part 11 and form through-holes in walls of the cardboard box 33 other than the lower wall.

Below, these configurations are described concretely one by one.

### <Cardboard Box 33>

Referring to FIG. 3, the cardboard box 33 which is a target to be unpacked by the end effector 10 has a well-known structure. Generally, the cardboard box 33 has a rectangular parallelepiped shape. In this embodiment, six walls of the cardboard box 33 are classified, based on their functions, into a lid wall through which the contents are taken in and out, a bottom wall which is a wall opposing to the lid wall and is opened by being cut, and side wall(s) which connects these two walls and enclose the contents.

Meanwhile, in the present disclosure the wall in which the flap(s) is cut open needs to be specified, and either one of the lid wall and the bottom wall is possible to be “the wall to be specified” depending on the contents. Below, although the bottom wall is “the wall to be specified,” the lid wall may be “the wall to be specified.”

In the claims, since the concept that encompasses the lid wall and the bottom wall is required, the cardboard box is considered to be a rectangular pillar shape, and the concept of the “end wall(s)” is used as the concept that encompasses the lid wall and the bottom wall.

Below, although the common cardboard box 33 in which both of the lid wall and the bottom wall are comprised of the flaps 33b is used, a cardboard box 33 in which only the lid wall is comprised of the flaps 33b and the lid wall is to be opened may also be used.

In detail, here, the cardboard box 33 has four flaps 33 at each of an upper end and a lower end of the four side walls of the body part 33a, respectively. As being well-known, the four flaps 33b at the lower ends of the four side walls are folded and fixed mutually and to the side walls with an adhesive tape 34 in an H-shape to constitute the bottom wall. Then, for example, in a state where the bottom wall is oriented downwardly and the four flaps 33b at the upper ends of the four side walls are opened, the contents are stuffed into the cardboard box 33. Then, as described above, the four flaps 33b at the upper ends of the four side walls are folded and fixed mutually and to the side walls with the adhesive tape 34 in the H-shape to constitute the lid wall.

As clear from the above description, since there are two cases: a case where the cardboard box 33 is placed so that the lid wall is turned upwardly and a case where the cardboard box 33 is placed so that the bottom wall is turned upwardly, below, the “end wall” located at the upper side in the placed state is referred to as an “upper wall”, and the “end wall” located at the lower side in the placed state is referred to as a “lower wall.”

Note that the number of flaps 33b is not limited in particular, but it may be one or more. Moreover, the mode of fixing the flap 33b is not limited in particular. The mode may be a mode in which the flaps are fixed mutually or to the side walls by an adhesive material other than the adhesive tape 34, or a mode in which the flaps are engaged mutually or with the side walls.

### <Contents 36>

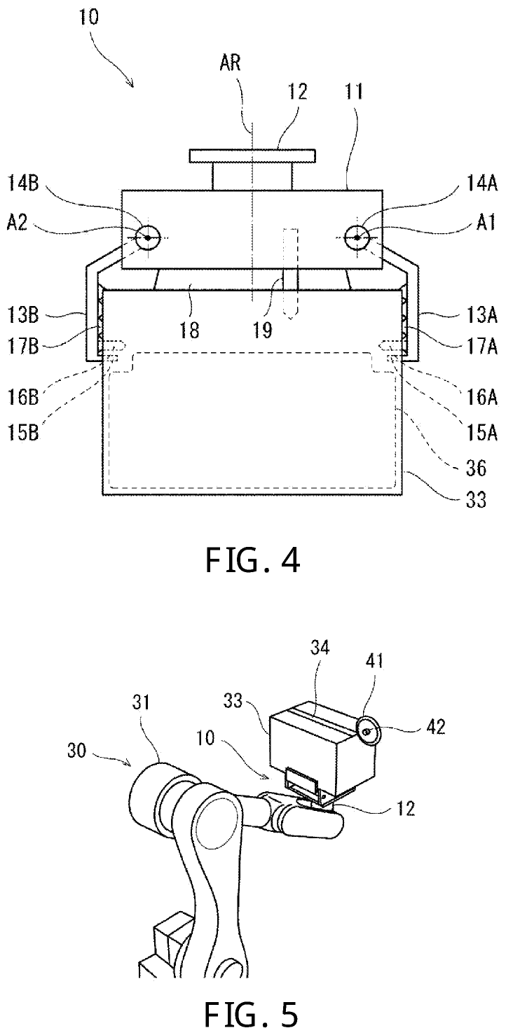

The contents 36 (see FIG. 4) are not limited in particular. However, the contents 36 to which the operation and effects unique to the present disclosure are applicable are the contents 36 which do not come out from the box only by the self-drop (dropping by their own weight) when the opened surface of the cardboard box 33 is turned downwardly. For example, such contents 36 may be what has a small specific gravity, and when they are stuffed into the cardboard box 33, they cause a frictional force with the side walls of the cardboard box 33 due to the elasticity of the contents 36 and the elasticity of the cardboard box 33. In detail, they may be plastic bags stuffed with nuts.

### <Robot 30>

The robot 30 may be any kind of robots in which the end effector 10 is able to be attached to a tip-end part thereof and which can invert the cardboard box 33 held by the end effector 10 in the up-and-down direction. This is because the cutting of the upper wall or the lower wall can be performed also by moving the cutter.

Although the robot 30 is an articulated robot, it may be robots of other types.

The robot 30 includes the robotic arm 31 and a controller which controls operation of the robotic arm 31. Here, a controller 80 which controls the operation of the end effector 10 is used as the controller.

### <End Effector 10>

Referring to FIGS. 1 and 3, here, the end effector 10 includes the body part 11, an attaching part 12, a pair of swinging members 13A and 13B, a suction part 18, an upper wall nozzle 19, and a three-dimensional (3D) position measuring instrument 20.

When seen in the left-and-right direction, the body part 11 is formed in a frame which has a cross section of an inverted U-shape and extends in the left-and-right direction (particularly, see FIG. 3).

A cylindrical attaching part 12 having a flange at a tip end thereof is provided so as to stand from the center part of the body part 11. The center axis of the attaching part 12 constitutes a reference axis AR of the end effector 10. The end effector 10 is attached to the tip-end part (wrist part) of the robotic arm 31 so that the reference axis AR is in agreement with a twist-rotation axis of the tip-end part. Moreover, as will be described later, the end effector 10 is disposed such that, by the robotic arm 31, the body part 11 is located above the cardboard box 33 and the reference axis AR is substantially in agreement with the center axis of the cardboard box 33.

FIG. 1 illustrates the end effector 10 in a posture in which the reference axis AR extends in the up-and-down direction (vertical direction).

The pair of swinging members 13A and 13B are attached at respective base-end parts to the body part 11 so as to be separated by a given distance L in a given direction perpendicular to the reference axis AR (here, the left-and-right direction). The base-end parts of the pair of swinging members 13A and 13B are attached to the body part 11 rotatably on a pair of rotation axes A1 and A2, respectively, vertical (perpendicular) to the extending direction of the reference axis AR and the given direction described above. The parts of the body part 11 to which the base-end parts of the pair of swinging members 13A and 13B, respectively, are attached are separated in the given direction described above by an equal distance from the reference axis AR of the body part 11.

For example, the pair of swinging members 13A and 13B are formed in a plate shape having such a cross-sectional shape that, when seen in the extending directions of the respective rotation axes A1 and A2, they are bent in a direction or to the side in which the pair of swinging members 13A and 13B approach each other (hereinafter, inward or inside).

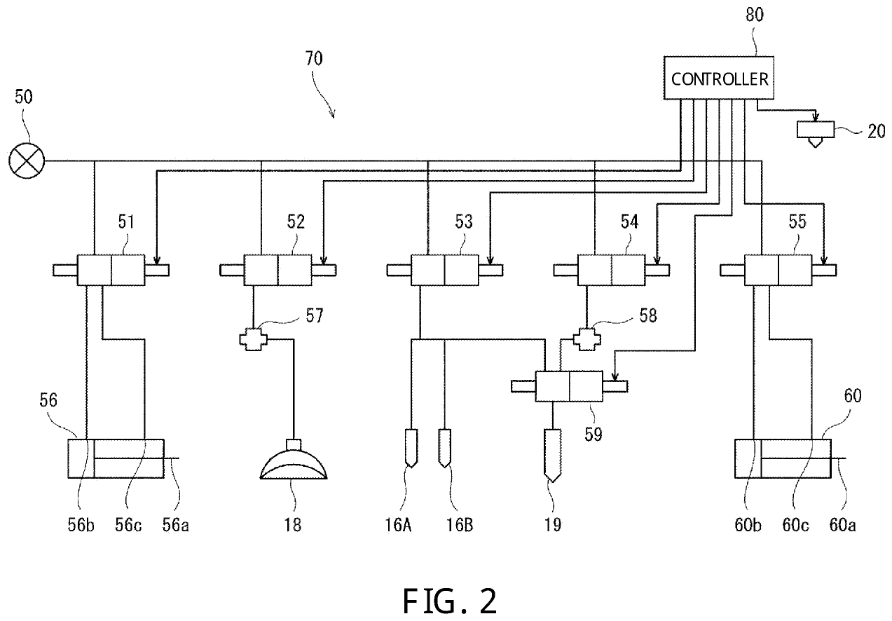

The tip ends of the pair of swinging members 13A and 13B are provided with the pawls 15A and 15B which protrude inwardly, respectively. Moreover, the tip-end parts of the pair of swinging members 13A and 13B are provided with the side wall nozzles 16A and 16B which protrude inwardly, respectively. Moreover, the friction members 17A and 17B are attached to the parts of the inner surfaces of the pair of swinging members 13A and 13B on the tip-end sides from the curved parts, respectively. The pair of side wall nozzles 16A and 16B penetrate the pair of friction members 17A and 17B, respectively. The pair of side wall nozzles 16A and 16B are connected to a pneumatic circuit 70 (see FIG. 2), as will be described later. The pair of friction members 17A and 17B may be members with a large friction coefficient, and may be members made of rubber, sponge, or sandpaper.

The length and the degree of bending of the pair of swinging members 13A and 13B are set (designed) so that, in a state where the body part 11 is located above the cardboard box 33 (in detail, in a state where the suction part 18 sucks the center part of an upper surface of the cardboard box 33), for example, the pair of pawls 15A and 15B stick into the upper parts of the left-and-right side walls of the cardboard box 33, respectively, the pair of side wall nozzles 16A and 16B penetrate the upper parts of the left-and-right side walls of the cardboard box 33, respectively, and the pair of friction members 17A and 17B contact the upper parts of the left-and-right side walls of the cardboard box 33, respectively.

However, depending on the state of the contents (for example, when the contents are few), the length and the degree of bending of the pair of swinging members 13A and 13B may be set (designed) so that, in the state where the body part 11 is located above the cardboard box 33 (in detail, in the state where the suction part 18 sucks the center part of the upper surface of the cardboard box 33), the pair of pawls 15A and 15B stick into any parts of the left-and-right side walls of the cardboard box 33, the pair of side wall nozzles 16A and 16B penetrate any parts of the left-and-right side walls of the cardboard box 33, and the pair of friction members 17A and 17B contact any parts of the left-and-right side walls of the cardboard box 33.

The suction part 18 is provided to a lower surface of the body part 11. The suction part 18 is comprised of a vacuum suction pad, for example. The suction part 18 is provided, for example, so that the center axis is in agreement with the reference axis AR. The suction part 18 is connected to a pressurized air supply 50 (see FIG. 2), as will be described later.

Moreover, the upper wall nozzle 19 is provided to the lower surface of the body part 11. The upper wall nozzle 19 extends in the extending direction of the reference axis AR, and is driven to advance and retreat in the extending direction of the reference axis AR by a pneumatic cylinder 60 (see FIG. 2) described later. The upper wall nozzle 19 is driven to advance and retreat so that it penetrates the upper wall (here, the lid wall) of the cardboard box at an operating position (advanced position) and separates from the upper wall at a standby position (retreated position).

Moreover, the 3D position measuring instrument 20 which measures a three-dimensional (3D) position of the cardboard box 33 is provided to a side part of the body part 11. The 3D position measuring instrument 20 is comprised of a three-dimensional vision camera, for example.

### {Configuration of Control System}

FIG. 2 is a block diagram illustrating a configuration of a control system of the end effector 10 of this embodiment. Referring to FIGS. 1 and 2, the end effector 10 is provided with the pneumatic circuit 70. This pneumatic circuit 70 is connected to the pressurized air supply 50. Here, the pressurized air supply 50 is provided externally to the end effector 10. Of course, the pressurized air supply 50 may be provide to the end effector 10. The pressurized air supply 50 is comprised of an air pump, for example.

First to fifth control valves 51-55 are connected to the pressurized air supply 50 in parallel. A first pneumatic cylinder 56 is connected to the first control valve 51. The base-end parts of the pair of swinging members 13A and 13B are connected with a piston rod 56a of the first pneumatic cylinder 56 through a given power transmission device, respectively. When the first control valve 51 switches the supply destination of the pressurized air between a pair of air supply ports 56b and 56c of the first pneumatic cylinder 56, the piston rod 56a of the first pneumatic cylinder 56 advances and retreats accordingly, and the pair of swinging members 13A and 13B swing so as to open and close accordingly.

A negative pressure generator 57 is connected to the second control valve 52. The negative pressure generator 57 is an instrument which generates negative pressure by using pressurized air, and, is generally referred to as a vacuum generator (ejector). The negative pressure generator 57 may be CONVUM®. The suction part 18 is connected to the negative pressure generator 57. When the second control valve 52 supplies the pressurized air to the negative pressure generator 57 and suspends the supply of the pressurized air, the negative pressure generator 57 supplies the negative pressure to the suction part 18 and suspends the supply of the negative pressure accordingly, and the suction part 18 sucks external air and suspends the suction of external air accordingly.

The pair of side wall nozzles 16A and 16B are connected to the third control valve 53. When the third control valve 53 supplies the pressurized air to the pair of side wall nozzles 16A and 16B and suspends the supply of the pressurized air, the pair of side wall nozzles 16A and 16B discharge the pressurized air and suspend the discharge of the pressurized air accordingly.

A negative pressure generator 58 is connected to the fourth control valve 54, and an input side of a sixth control valve 59 is connected to the negative pressure generator 58. The negative pressure generator 58 may be CONVUM®. Moreover, the input side of the sixth control valve 59 is connected to the third control valve 53. Further, the upper wall nozzle 19 is connected to an output side of the sixth control valve 59. The sixth control valve 59 switches the connecting destination of the upper wall nozzle 19 between the negative pressure generator 58 and the third control valve 53.

In a state where the sixth control valve 59 connects the upper wall nozzle 19 to the third control valve 53, when the third control valve 53 supplies the pressurized air to the upper wall nozzle 19 and suspends the supply of the pressurized air, the upper wall nozzle 19 discharge the pressurized air and suspends the discharge of the pressurized air accordingly.

In a state where the sixth control valve 59 connects the upper wall nozzle 19 to the negative pressure generator 58, when the fourth control valve 54 supplies the pressurized air to the negative pressure generator 58 and suspends the supply of the pressurized air, the negative pressure generator 58 supplies the negative pressure to the upper wall nozzle 19 and suspends the supply of the negative pressure accordingly, and the upper wall nozzle 19 sucks external air and suspends the suction of external air accordingly.

The second pneumatic cylinder 60 is connected to the fifth control valve 55. The upper wall nozzle 19 is connected to a piston rod 60a of the second pneumatic cylinder 60 through a given power transmission device. When the fifth control valve 55 switches the supply destination of the pressurized air between a pair of air supply ports 60b and 60c of the second pneumatic cylinder 60, the piston rod 60a of the second pneumatic cylinder 60 advances and retreats accordingly, and the upper wall nozzle 19 advances and retreats accordingly, as described above.

The first to sixth control valves 51-55 and 59, the first and second pneumatic cylinders 56 and 60, and the negative pressure generators 57 and 58 are installed in the body part 11 of the end effector 10.

The controller 80 is comprised of a sole controller which carries out a centralized control or a plurality of controllers which carry out a distributed control. Here, the controller 80 is comprised of the sole controller which carries out the centralized control. The controller 80 is provided with a processor and a memory, for example. The controller 80 controls the operations of the end effector 10 and the robotic arm 31 by the processor reading and executing a given operation program stored in the memory. In detail, the controller 80 is comprised of a microcontroller, an MPU, an FPGA (Field Programmable Gate Array), a PLC (Programmable Logic Controller), or a logic circuit, for example.

In detail, the controller 80 controls operations of the pair of swinging members 13A and 13B, the suction part 18, the pair of side wall nozzles 16A and 16B, and the upper wall nozzle 19 by controlling operations of the first to sixth control valves 51-55 and 59. Moreover, here, the controller 80 also serves as a robot controller, which controls the operation of the robotic arm 31. Therefore, the robotic arm 31 and the controller 80 constitute the robot 30.

Further, the controller 80 controls operation of the 3D position measuring instrument 20, and identifies the 3D position of the cardboard box 33 based on the 3D position measured by the 3D position measuring instrument 20. Therefore, the 3D position measuring instrument 20 and the controller 80 constitute a box position identifying part.

The controller 80 is installed in a pedestal (not illustrated) of the robotic arm 31, for example. However, the installation location of the controller 80 is not limited in particular.

### [Operation]

Next, the operations of the end effector 10 configured as described above and the robotic arm 31 to which the end effector 10 is attached to the tip-end part thereof are described. These operations are carried out by the controller 80 controlling the end effector 10 and the robotic arm 31.

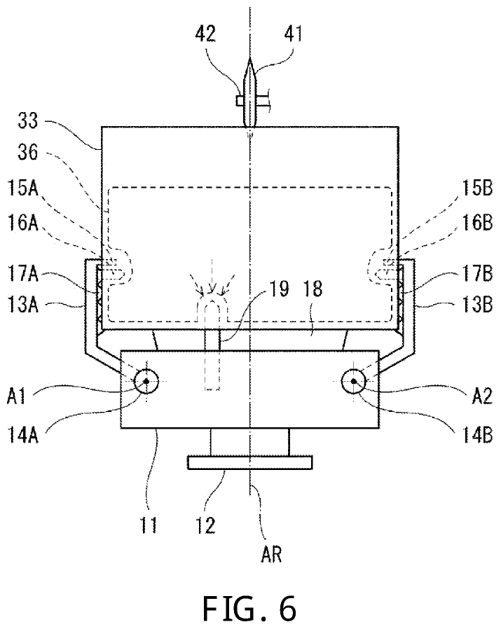

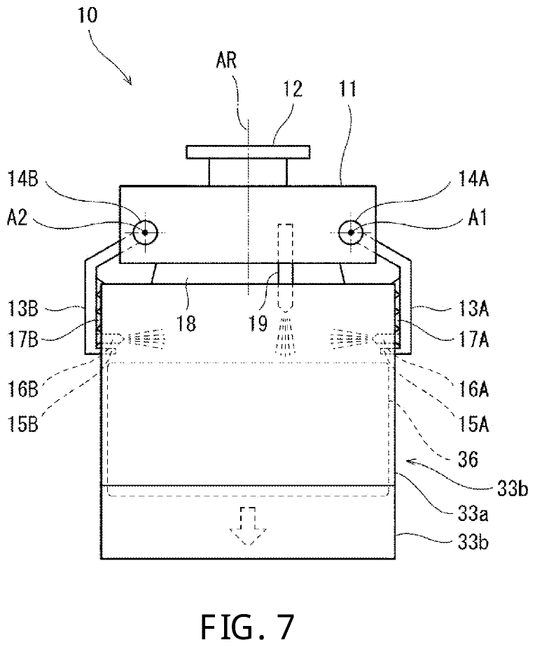

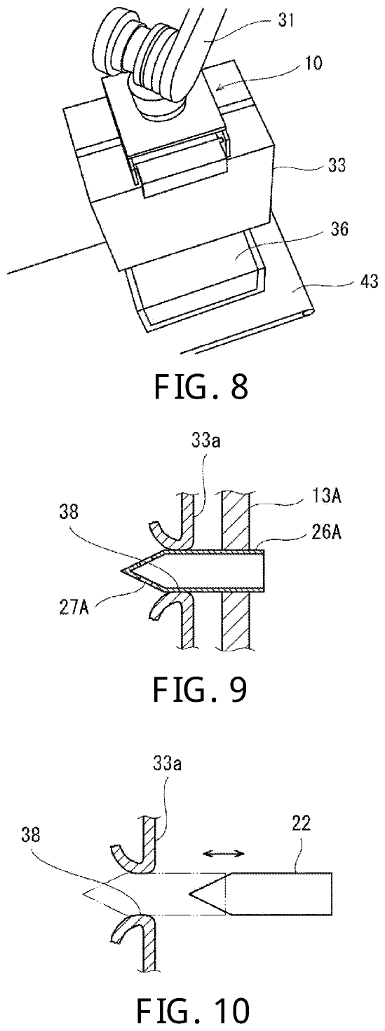

FIG. 3 is a perspective view illustrating a lifting operation of the cardboard box 33 by the robotic arm 31. FIG. 4 is a front view illustrating the end effector 10 in a state where it holds the cardboard box 33. FIG. 5 is a perspective view illustrating a cutting operation of the lower wall of the cardboard box 33 by the robotic arm 31. FIG. 6 is a front view illustrating the end effector 10 when cutting the lower wall of the cardboard box 33. FIG. 7 is a front view illustrating the end effector 10 in a state where it drops the contents 36 from the cardboard box 33 of which the lower wall is opened. FIG. 8 is a perspective view illustrating an operation where the contents are dropped by the robotic arm 31 from the cardboard box 33 of which the lower wall is opened.

Referring to FIG. 3, the end effector 10 is attached to the tip-end part of the robotic arm 31. On the other hand, a plurality of cardboard boxes 33 are stacked on a pallet (not illustrated). A reference character 39 represents a mountain of the stacked cardboard boxes. For example, many plastic bags which are filled with nuts are stuffed into the cardboard box 33, and the upper and lower flaps 33b are fixed by the tape 34 to constitute the lid wall and the bottom wall. The cardboard boxes 33 are stacked so that the lid wall is turned upwardly.

Referring to FIGS. 1-4, by the 3D position measuring instrument 20 and the controller 80, the position of one cardboard box 33 at the top stage of the mountain 39 of the stacked cardboard boxes 33 is identified, and the robotic arm 31 places the body part 12 of the end effector 10 at the center part of the upper surface of the identified cardboard box 33.

Then, the suction part 18 of the end effector 10 sucks the upper surface of the cardboard box 33. At this time, the upper wall nozzle 19 penetrates the upper wall (lid wall) of the cardboard box 33, and advances to the operating position.

Then, the robotic arm 31 lifts the cardboard box 33 to a given height. In this state, the pair of swinging members 13A and 13B of the end effector 10 swing so as to close. In this manner, the pair of pawls 15A and 15B stick into the upper parts of the pair of side walls of the cardboard box 33, respectively, and the pair of friction members 17A and 17B are pressed against the upper parts of the pair of side walls of the cardboard box 33, respectively. Therefore, the cardboard box 33 is firmly gripped by the pair of swinging members 13A and 13B. Moreover, in this case, the pair of side wall nozzles 16A and 16B penetrate the upper parts of the pair of side walls of the cardboard box 33, respectively, and advance to the operating position. In this state, the contents 36 of the cardboard box 33 move to a lower part of the cardboard box 33.

Then, referring to FIGS. 5 and 6, the robotic arm 31 inverts the cardboard box 33 so that the lower wall (bottom wall) is turned upwardly. At this time, the upper wall nozzle sucks air inside the cardboard box 33. Therefore, the contents 36 which moved toward the lower wall located at the upper side of the cardboard box 33 now move toward the upper wall located at the lower side of the cardboard box 33 by the suction and their own weight, thereby forming a gap sufficient for the cutting (described later) between the lower wall of the cardboard box 33 and the contents 36.

Meanwhile, a cutter 41 is disposed in this work environment. The structure of the cutter 41 is not limited in particular, so long as it is capable of cutting between the flaps 33b of the cardboard box 33. Here, the cutter 41 is fixed to a suitable support member 42.

The robotic arm 31 cuts the tape 34 at the joined part of the flaps of the lower wall (bottom wall) of the cardboard box 33 (and the flaps 33b and the lower wall), while moving the cardboard box 33. Note that, in FIG. 5, only the tape 34 pasted so as to extend in the longitudinal direction at the center part of the lower wall in the short-side direction is illustrated, and illustration of other tapes is omitted. Of course, other tapes pasted to the lower wall (and the flaps 33b and the lower wall) are also cut. Therefore, the lower wall of the cardboard box 33 is opened. Here, in the cardboard box 33, since the sufficient gap is formed between the contents 36 and the lower wall, the lower wall can be cut without damaging the contents 36.

Then, referring to FIGS. 7 and 8, the robotic arm 31 conveys the cardboard box 33, for example, to above a carrying conveyer 43, and inverts it so that the lower wall is turned downwardly.

At this time, in the end effector 10, the upper wall nozzle 19 suspends the suction of air, and discharges the pressurized air. Moreover, the pair of side wall nozzles 16A and 16B discharge the pressurized air.

Therefore, the contents 36 are pushed downwardly by the pressurized air discharged from the upper wall nozzle 19. Moreover, the frictional force between the contents 36 and the pair of side walls is reduced by the pressurized air discharged from the pair of side wall nozzles 16A and 16B. Moreover, when the contents 36 slip downwardly from the pair of side wall nozzles 16A and 16B, the air discharged from the pair of side wall nozzles 16A and 16B pushes the contents 36 downwardly. The self-dropping of the contents 36 is greatly stimulated by the effects.

As a result, the contents 36 fall on the carrying conveyer 43 smoothly.

As described above, according to this embodiment, the contents 36 can be easily taken (picked) out from the cardboard box 33.

### [Modification 1]

FIG. 9 is a cross-sectional view illustrating a configuration of a left side wall nozzle 26A of the end effector 10 according to Modification 1. Referring to FIGS. 1 and 9, Modification 1 differs from the end effector 10 of FIG. 1 in that the end effector 10 includes the left side wall nozzle 26A of FIG. 9 and a right side wall nozzle (not illustrated) which is configured similarly to the left side wall nozzle 26A, instead of the pair of side wall nozzles 16A and 16B of FIG. 1, and an upper wall nozzle (not illustrated) configured similarly to the left side wall nozzle 26A, instead of the upper wall nozzle 19 of FIG. 1, and other configurations are similar to those of the end effector 10 of FIG. 1. Below, the difference is described.

Referring to FIG. 9, in this modification, the left side wall nozzle 26A is provided to the left-hand side swinging member 13A. The left side wall nozzle 26A is formed in a cylindrical shape of which a tip-end part is sharpened. A plurality of through-holes 27A are formed in the tip-end part of the left side wall nozzle 26A. Moreover, a base end of the left side wall nozzle 26A is opened. The right side wall nozzle configured similarly to the left side wall nozzle 26A is provided to the right-hand side swinging member 13B.

Moreover, referring to FIG. 1, the upper wall nozzle (not illustrated) configured similarly to the left side wall nozzle 26A is provided to the body part 11, instead of the upper wall nozzle 19. The upper wall nozzle is driven to advance and retreat by the second pneumatic cylinder 60, similarly to the upper wall nozzle 19 of FIG. 1.

In the modification configured in this way, when the pair of swinging members 13A and 13B swing so as to close, the left side wall nozzle 26A and the right side wall nozzle penetrate the pair of side walls of the body part 33a of the cardboard box 33 to form holes 38. Moreover, when the upper wall nozzle is driven so as to advance to the operating position, the upper wall nozzle penetrates the upper wall of the body part 33a of the cardboard box 33 to form a hole. Therefore, the inside of the cardboard box 33 communicates with the outside through the left side wall nozzle 26A, the right side wall nozzle, and the upper wall nozzle.

Therefore, as illustrated in FIG. 7, when the cardboard box 33 is inverted so that the opened lower wall is turned downwardly by the robotic arm 31, the contents 36 of the cardboard box 33 fall by their own weight. Then, even if the gap is produced between the contents 36 which slipped down to the middle and the upper wall, since external air is supplied to the gap through the left side wall nozzle 26A, the right side wall nozzle, and the upper wall nozzle, it is suppressed that the gap becomes at negative pressure, thereby stimulating the self-dropping of the contents 36. Therefore, the contents 36 can be easily taken out from the cardboard box 33.

### [Modification 2]

FIG. 10 is a cross-sectional view illustrating a configuration of a punch member 22 of the end effector 10 according to Modification 2. Referring to FIGS. 1 and 10, Modification 2 differs from the end effector 10 of FIG. 1 in that the end effector 10 is provided with punch members 22 of FIG. 9, instead of the pair of side wall nozzles 16A and 16B and the upper wall nozzle 19 of FIG. 1, and other configurations are similar to those of the end effector 10 of FIG. 1. Below, the difference is described.

Referring to FIG. 10, the punch member 22 is formed in a cylindrical shape of which a tip end is sharpened. The punch member 22 is driven to advance and retreat between the operating position (advanced position) and the standby position (retreated position) by a pneumatic cylinder (not illustrated) connected to the pneumatic circuit 70. When the punch member 22 is driven so as to advance to the operating position, it penetrates the pair of side walls or the upper wall of the body part 33a of the cardboard box 33 to form the hole 38. Then, when the punch member 22 is driven to retreat to the standby position, the inside of the cardboard box 33 communicates with the outside through the hole 38.

This punch members 22 are provided to the end effector 10 of FIG. 1, instead of the pair of side wall nozzles 16A and 16B and the upper wall nozzle 19.

In the modification configured in this way, when the pair of swinging members 13A and 13B swing to close, the pair of punch members provided to these members are driven to advance and retreat and form the holes 38 in the pair of side walls of the body part 33a of the cardboard box 33. Moreover, the punch member 22 provided to the lower surface of the body part 12 is driven to advance and retreat and forms the hole 38 in the upper wall of the body part 33a of the cardboard box 33. Therefore, the inside of the cardboard box 33 communicates with the outside.

Therefore, as illustrated in FIG. 7, when the cardboard box 33 is inverted so that the opened lower wall is turned downwardly by the robotic arm 31, the contents 36 of the cardboard box 33 fall by their own weight. Then, even if the gap is produced between the contents 36 which slipped down to the middle and the upper wall, since external air is supplied to the gap through the hole 38, it is suppressed that the gap becomes at negative pressure, thereby stimulating the self-dropping of the contents 36. Therefore, the contents 36 can be easily taken out from the cardboard box 33.

### OTHER EMBODIMENTS

Although in the above embodiment the box holding part is provided with the upper wall holding part (18) and the pair of side wall holding parts (13A, 13B), either one may be provided.

Moreover, although in the above embodiment the cardboard boxes 33 are stacked, the placement form of the cardboard boxes 33 is not limited to this configuration. For example, a row of cardboard boxes may be stacked in a plurality of stages. In such a case, the upper wall holding part (18) may be omitted.

Moreover, the direction in which the end effector 10 holds the cardboard box 33 is not limited in particular. For example, when the cardboard box 33 is placed so that the lid wall is oriented laterally or downwardly, the end effector 10 may hold the cardboard box 33 from the side or below. In short, the end effector 10 may hold the cardboard box 33 so that the body part 11 becomes adjacent to an end wall opposite from the end wall of the cardboard box 33 to be opened.

Moreover, the box holding part may hold the cardboard box 33 by supporting a part of the cardboard box 33 other than the end wall to be opened, and, for example, it may hold a ridge part or a corner part of the cardboard box 33.

Although in the above embodiment the suction part 18 is illustrated as the upper wall holding part, the upper wall holding part may be any part which is capable of holding and supporting the upper wall of the cardboard box 33. For example, the upper wall holding part may be provided with a pawl which can stick into the upper wall to support the cardboard box 33.

Although in the above embodiment the side wall holding part is comprised of the pair of swinging members 13A and 13B, the side wall holding part may be any part which is capable of holding the cardboard box 33 by supporting the side walls. For example, the side wall holding part may be configured to pinch the pair of side walls by advancing and retreating in the left-and-right direction.

Although in the above embodiment both of the pair of side wall nozzles 16A and 16B and the upper wall nozzle 19 are provided, only either one may be provided. This is similar for the pair of side wall nozzles and the upper wall nozzle in Modification 1, and the punch members 22 in Modification 2.

Moreover, although in the above embodiment the mobile elements (13A, 13B, 19) of the end effector are driven by the pressurized air supply 50, the power source of the mobile elements is not limited to this configuration. For example, the mobile elements (13A, 13B, 19) may be driven by a motor.

Moreover, in the above embodiment, the 3D position measuring instrument 20 may be omitted.

It is apparent for the person skilled in the art that many improvements and other embodiments are possible from the above description. Therefore, the above description is to be interpreted only as illustration.

### INDUSTRIAL APPLICABILITY

The end effector and the robot of the present disclosure are useful as the end effector which is capable of easily taking out the contents from the cardboard box by stimulating the self-dropping of the contents when unpacking the cardboard box by using the robot, and as the robot to which the end effector is attached (mounted).

### DESCRIPTION OF REFERENCE CHARACTERS

10 End Effector
11 Body Part
12 Attaching Part
13A, 13B Swinging Member
15A, 15B Pawl
16A, 16B Side Wall Nozzle
17A, 17B Friction Member
18 Suction Part
19 Upper Wall Nozzle
20 Three-dimensional Position Measuring Instrument
22 Punch Member
26A Left Side Wall Nozzle
30 Robot
31 Robotic Arm
33 Cardboard Box
33a Body Part
33b Flap
34 Tape
36 Contents
41 Cutter
42 Support Member
50 Pressurized Air Supply
51-55 First to Fifth Control Valves
56 First Pneumatic Cylinder
57, 58 Negative Pressure Generator
59 Sixth Control Valve
60 Second Pneumatic Cylinder
70 Pneumatic Circuit
80 Controller
A1, A2 Rotation Axis
AR Reference Axis
L Given Distance

1. An end effector to be attached to a tip-end part of a robotic arm and configured to unpack a cardboard box of which one or more flaps provided to one end of a side wall are fixed mutually or to the side wall to constitute one of end walls, comprising:
a body part to be attached to the tip-end part of the robotic arm;
a box holding part provided to the body part and configured to hold the cardboard box by holding a part of the cardboard box other than the one end wall; and
a punching part provided to the body part and configured to form a through-hole in a wall of the cardboard box other than the one end wall.

2. The end effector of claim 1, wherein the box holding part includes:
an end-wall holding part configured to hold the other end wall of the cardboard box; and
a pair of side wall holding parts configured to hold a pair of side walls of the cardboard box opposing to each other, and
wherein the punching part forms the through-hole in the other end wall and/or the side wall of the cardboard box.

3. The end effector of claim 2, wherein the end-wall holding part is a suction part configured to suck the other end wall of the cardboard box.

4. The end effector of claim 2, wherein the pair of side wall holding parts include a pair of swinging members, each having a pawl and/or a friction member, and
wherein, when the body part is located above the other end wall of the cardboard box, the pair of swinging members swing centering on a part of the body part located above the pair of side walls to stick the pawls into and/or press the friction members against the pair of side walls, respectively, to grip the cardboard box.

5. The end effector of claim 2, wherein the punching part includes:
a nozzle configured to discharge at least pressurized air; and
a nozzle moving mechanism configured to move the nozzle between an operating position where the nozzle penetrates the other end wall or the side wall of the cardboard box and a standby position where the nozzle separates from the other end wall or the side wall of the cardboard box.

6. The end effector of claim 5, wherein the nozzle is an end wall nozzle configured to suck air and discharge pressurized air, and
wherein the nozzle moving mechanism is an end wall nozzle moving mechanism configured to move the nozzle between an operating position where the end wall nozzle penetrates the other end wall of the cardboard box and a standby position where the nozzle separates from the other end wall of the cardboard box.

7. The end effector of claim 6, wherein the pair of side wall holding parts include a pair of swinging members, each having a pawl and/or a friction member,
wherein, when the body part is located above the cardboard box, the pair of swinging members swing centering on a part of the body part located above the pair of side walls to stick the pawls and/or press the friction members into the pair of side walls, respectively, to grip the cardboard box,
wherein the pair of swinging members constitutes the nozzle moving mechanism,
wherein the nozzle is a pair of side wall nozzles configured to discharge pressurized air, and
wherein the pair of side wall nozzles are provided to the pair of swinging members so that, when the pair of swinging members swing so that the pair of swinging members grip the cardboard box, the pair of side wall nozzles penetrate the pair of side walls of the cardboard box, and when the pair of swinging members swing so that the pair of swinging members release the cardboard box, the pair of side wall nozzles separate from the pair of side walls of the cardboard box.

8. The end effector of claim 1 comprising:
a three-dimensional position measuring instrument configured to measure the position of the cardboard box; and
a box position identifying part configured to identify the three-dimensional position of the cardboard box based on the three-dimensional position measured by the three-dimensional position measuring instrument.

9. A robot in which the end effector of claim 1 is attached to the tip-end part of the robotic arm.
